(19) United States
(12) Patent Application Publication
(10) Pub. No.: US 2006/0134307 A1
(43) Pub. Date: Jun. 22, 2006

(54) Starch comprising and ready-to-serve ambient stable fruit-based composition

(75) Inventors: Bernard Charles Sekula, Glen Gardner, NJ (US); Sudarshi Regismond, Vlaardingen (NL); Leonardo Jose Sanchez Aquino, Jersey City, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods, North America, Division of Conopco, Inc.

(21) Appl. No.: 11/017,289

(22) Filed: Dec. 20, 2004

(51) Int. Cl. A23L 1/212

(52) U.S. Cl. 426/615

(57) ABSTRACT

Ambient stable fruit-based compositions are described. The compositions are ready-to-eat, low in fat and suitable to be fillings, dips, sauces, spreads or dressings. The compositions have a fork-mashed texture and do not contain fork-mashed fruit.

### FIELD OF THE INVENTION

The present invention is directed to a ready-to-serve and ambient stable fruit-based composition. More particularly, the invention is directed to a ready-to-serve and ambient stable fruit-based composition having a fork-mashed texture. The fruit-based composition of this invention is low in fat, starch and insoluble fiber comprising, and suitable to be a filling, dip, sauce, spread, dressing or the like. The fruit-based composition of this invention can be prepared from ripened and/or over ripened fruit, and is ambient stable after opening. Moreover, the ready-to-serve and ambient stable fruit-based composition of this invention surprisingly maintains its fork-mashed appearance for the duration of its shelf-life, notwithstanding the fact that the same can be made free of fork-mashed fruit.

### BACKGROUND OF THE INVENTION

Consumption of nutrients, like antioxidants and folic acid, which are abundant in fruits and vegetables, has been linked to a lower incidence of cardiovascular disease. Moreover, it is well settled that eating fruits high in soluble fiber can reduce cholesterol levels, which protects against atherosclerosis.

Other advantages of having a diet high in fruit include better athletic performances, reduced risk of developing chronic bronchitis, a lowered risk of getting most common cancers (including breast cancer), as well as a lowered risk of getting cataracts. Additionally, fruits, like avocado, contain protein, vitamin E, vitamin C, and beta-carotene and are often linked to stroke prevention.

While food products comprising fruits and vegetables have been linked to health benefits in humans, such products are often difficult to prepare for sale in commerce. This is true because the quality of food products comprising fruit often deteriorates (e.g., loses texture, browns, darkens, grows mold and/or loses flavor) due to enzymatic reactions within the food product. These reactions result in a product that has a short shelf-life and does not have an appealing look, taste or texture after spending a limited period of time in conventional commercial channels.

Known techniques have been used to inhibit the deterioration of food products comprising fruits and/or vegetables. These techniques include pasteurization of the fruit, high vacuum processing for removing oxygen, and chemically treating the fruit with sulfiting agents before making the food product. The aforementioned techniques do not completely eliminate, for example, browning and darkening in food products comprising fruit, and such techniques have adverse effects on the flavor, aroma, texture and nutritional value of the fruits and vegetables treated, as well as the food products prepared therefrom.

It is of increasing interest to develop a ready-to-serve and ambient stable fruit-based composition that does not, for example, lose flavor, brown, darken and lose its mash texture, and that has an extended shelf-life at ambient temperature. This invention, therefore, is directed to a ready-to-serve and ambient stable fruit-based composition that, preferably, has not been subjected to chemical treatment, high vacuum processing and temperatures over about 80° C. The ready-to-serve and ambient stable fruit-based composition of this invention is low in fat, comprises starch and insoluble fiber, and is suitable to be a filling, dip, sauce, spread, dressing or the like. Moreover, the ready-to-serve and ambient stable fruit-based composition of this invention can be prepared from under ripe, ripened and/or over-ripened fruit, and is ambient stable after opening, and able to maintain its fork-mashed appearance for the duration of its shelf-life. Such a fruit-based composition has substantially the same visual, texture, aroma and taste attributes of a fork-mashed fruit-based composition made on demand from freshly picked fruits, notwithstanding the fact that the same is substantially free of (preferably free of) fork-mashed fruit.

### ADDITIONAL INFORMATION

Efforts have been disclosed for making fruit pulp. In U.S. Pat. No. 5,384,147, a method for processing avocado pulp is described.

Other efforts have been disclosed for making stabilized fruit. In U.S. Pat. No. 5,871,794, a guacamole composition with tomatillo pulp is described.

Still other efforts have been disclosed for making creamy food formulations. In U.S. Pat. No. 6,284,303, a vegetable based creamy food is described.

None of the additional information above describes a ready-to-serve and ambient stable fruit-based composition that is starch and insoluble fiber comprising with a fork-mashed texture. Moreover, none of the additional information describes a ready-to-serve, ambient stable fruit-based composition that can be made from under ripe, ripened and/or over ripened fruit, wherein the same is ambient stable after opening and maintains its fork-mashed appearance for the duration of its shelf-life.

### SUMMARY OF THE INVENTION

In a first aspect, the present invention is directed to an acidified fruit-based composition comprising:

(a) fruit;

(b) water;

(c) an acidulant; and

(d) a thickener mixture comprising starch and insoluble fiber

wherein the acidified fruit composition has a pH below about 4.0 and the thickener mixture comprises at least about 3.5% by weight starch and at least about 20.0% by weight insoluble fiber based on total weight of the thickener mixture.

In a second aspect, the present invention is directed to a ready-to-serve and ambient stable fruit-based composition comprising the acidified fruit composition of the first aspect of this invention.

In a third aspect, the present invention is directed to a method for making the ready-to-serve and ambient stable fruit-based composition of the second aspect of this invention.

Low in fat, as used herein, means less than about 40.0%, and preferably, less than about 25.0% by weight of the total weight of the ready-to-serve and ambient stable fruit-based composition but at least about 5.0% by weight of the total weight of the composition. Ambient stable, as used herein, means microbiologically stable (i.e., no outgrowths of bacteria, yeast and/or mold) and no flavor loss for at least about four (4) weeks after opening, and preferably, for at least about twenty (20) weeks after opening when kept covered and refrigerated at about 5° C.

Ambient stable also means that the fruit-based composition displays no browning, darkening, flavor change, texture change or separation (i.e., creaming) for at least about eight (8) weeks after opening when kept covered and refrigerated at about 5° C. Ripened fruit, as used herein, means a fruit that is sufficiently advanced and mature. Over ripe fruit means fruit that is softer and often sweeter than ripe fruit. Ready-to-serve means flavored with optional additives and ready for consumption by a consumer. Chemically treating means reacting with and not merely mixing fruit with commonly employed food grade acids. Fork-mashed means a soft pulpy appearance and texture with particles having a size from about 1.0 to about 5.0 millimeters in diameter, mash potato-like and free of starch breakdown due to the presence of enzymes, like amylase.

### DETAILED DESCRIPTION OF THE PREFERRED EMBODIMENTS

There is no limitation with respect to the type of fruit that may be used to make the ready-to-serve and ambient stable fruit-based composition of the present invention, as long as the fruit is one that is suitable for human consumption. Often, the fruit used in this invention is an avocado, banana, mango, guava, fig, papaya, kiwi, star fruit, pineapple, a combination thereof, or the like. In a most preferred embodiment, the fruit employed in this invention is avocado.

When selecting the fruit to make the acidified fruit-based composition of this invention, the fruit can be utilized under ripe, ripe, over ripe or as a mixture thereof, but preferably ripe.

When preparing the fruit selected for use in this invention, the ripe or over ripe fruit or mixture thereof is, in no particular order, peeled and depitted or cored, if necessary. The resulting fruit flesh can be acidified after being combined with starch and insoluble fiber, but preferably, the resulting fruit flesh is acidified then mashed or mashed then acidified to produce an acidified fruit composition (before starch and insoluble fiber are added). Typically, fruit flesh is first pureed, and subsequently, acidified in a mixing vessel, preferably operating at moderate shear, to produce the acidified fruit composition. In a preferred embodiment at least about 70.0%, and most preferably, at least about 95.0% to about 100.0% of all fruit employed in the acidified fruit composition of this invention is pureed. The amount of acid employed is such that the pH of the resulting ready-to-serve and ambient stable fruit-based composition is below about 4.0, and preferably, below about 3.65, and most preferably, below about 3.5. In yet another preferred embodiment, the pH of the resulting ambient stable and fruit-based composition of this invention is above about 2.00 but below 3.8, including all ranges subsumed therein.

In addition to the above mentioned pH values, the ambient stable and ready-to-serve fruit-based composition (regardless of the means for acidifying) preferably has extracellular terminal unsaturated ester at a level below about 20.0 ppm, and preferably, below about 5.0 ppm, and most preferably, about 0.0 ppm (resulting, from the acidification and moderate stirring as well as heat treatment when employed). In a most preferred embodiment, the extracellular terminal unsaturated ester is avocatin.

The acidulants suitable to acidify the fruit flesh used in this invention are limited only to the extent that they may be used in a product suitable for human consumption. Examples of the types of acidulants that may be used in this invention are acetic acid, hydrochloric acid, sulfuric acid, lactic acid, malic acid, phosphoric acid, mixtures thereof, and the like. Preferred acidulants are inorganic acids that have a pKa of 3.0 or less, and most preferably, 2.0 or less. The most preferred acidulants are phosphoric, hydrochloric and/or sulfuric acid with hydrochloric acid being especially preferred.

In yet another preferred embodiment, the amount of acid employed in this invention is, by weight, from about 90.0 to about 99.0 times, and preferably, from about 95.0 to about 99.0 times less than the weight of fruit employed in the ready-to-serve and ambient stable fruit-based composition.

When making the acidified fruit-based composition described herein, again, fruit can be combined with starch and insoluble fiber (i.e., water insoluble) and acid and/or acidified starch or insoluble fiber or both. Preferably, however, acidified fruit composition is combined with insoluble fiber, and starch is preferably added after any thermal processing, like pasteurization, when the starch is an acetylated distarch adipate.

The insoluble fibers suitable for use in this invention are found, for example, in fruits, both citrus and non-citrus. Other sources of the insoluble fibers suitable for use in this invention are vegetables like legumes, and grains. Preferred insoluble fibers suitable for use in this invention can be recovered from tomatoes, carrots, peaches, pears, apples, plums, lemons, limes, oranges, grapefruits or mixtures thereof. Other preferred insoluble fibers suitable for use in this invention may be recovered from the hull fibers of peas, oats, barley, mustard, soy, or mixtures thereof. Still other fibers, which may be employed, include those that are plant or root-derived as well as those which are wood-derived. Typically, the ready-to-serve and ambient stable fruit-based composition of this invention comprises from about 0.10% to about 10.0%, and preferably, from about 0.15% to about 4.5%, and most preferably, from about 0.25% to about 3.0% by weight insoluble fibers, based on total weight of the ready-to-serve and ambient stable fruit-based composition, and including all ranges subsumed therein. Such insoluble fibers are commercially available from suppliers like J. Rettenmaier and Sohne GMBH under the Vitacel name and Herbstreith & Fox under the Herbacel name. These insoluble fibers typically have lengths from about 25 to about 400 microns, and preferably, from about 50 to 185 microns, and most preferably, from about 100 to about 165 microns, including all ranges subsumed therein. The widths of such fibers are typically between about 3.0 to about 20.0 microns, and preferably, from about 5.0 to about 10.0 microns.

The starch (or combination of starches) suitable for use in this invention is typically derived from sources like tapioca, waxy maize, corn, potato, rice, wheat or cellulose. The starch employed can be modified, non-modified, instant or cook-up starch. Preferred starches suitable for use in this invention are instant starches like potato starches made available from Paselli under the Paselli FP name, and especially those starches classified as being oxidised or an acetylated distarch adipate, such as those identified with an E number of 1404 or 1422, respectively. Most preferred starches suitable for use in this invention are sold under the name Redi-Tex and Merigel 342 (from Tate & Lyle) and Pulp-Tex (from Cargill-Cerestar).

Typically, the ready-to-serve and ambient stable fruit-based composition of this invention comprises at least about 3.5% by weight starch and at least about 20.0% by weight insoluble fiber, based on total weight of thickener mixture. In a preferred embodiment, the amount of fiber employed in the thickener mixture is at least about 1.5 times, and preferably, at least about 2.0 but less than 3.5 times the amount of starch used. In another preferred embodiment, the amount of insoluble fiber employed is at least about 1.0% by weight of the ready-to-serve and the amount of starch employed is less than about 4.0% by weight of the ready-to-serve and ambient stable fruit-based composition.

Also, preferably added to the acidified fruit-based composition of this invention is oil, emulsifier and builder. The oil in this invention is limited only to the extent that it is suitable for human consumption. Illustrative examples of the types of oil which may be used in this invention include, without limitation, those which are liquid at ambient temperature like avocado, mustard, coconut, cottonseed, fish, flaxseed, grape, olive, palm, peanut, rapeseed, safflower, sesame, soybean, sunflower, mixtures thereof and the like.

Other types of oils which may be used (either alone or in combination with the oils that are liquid at ambient temperature) in this invention are solid at ambient temperature. Illustrative examples of the oils which are solid at room temperature and suitable for use in this invention include, without limitation, butter fat, chocolate fat, chicken fat, coconut oil, partially or fully hydrogenated vegetable oils like palm kernel oil and soybean oil, mixtures thereof and the like.

In a preferred embodiment, the oil used in this invention is a liquid at ambient temperature. In a most preferred embodiment, the oil used in this invention is soybean, sunflower or rapeseed oil or a mixture thereof.

The amount of oil used in the acidified fruit-based composition is enough to result in a ready-to-serve and ambient stable fruit-based composition that has more than about 5.0% by weight and less than about 40.0% by weight oil, based on total weight of the ready-to-serve and ambient stable fruit-based composition and including all ranges subsumed therein. Preferably, the amount of oil employed results in a ready-to-serve and ambient stable fruit-based composition that is from about 5.0% to about 35.0%, and most preferably, from about 10.0% to about 30.0% by weight, based on total weight of the ready-to-serve and ambient stable fruit-based composition and including all ranges subsumed therein. Fruit (not including optionally added fruit) typically makes up from about 10.0% to about 40.0%, and preferably, from about 15.0% to about 35.0% by weight of the total weight of the ready-to-serve and ambient stable fruit-based composition.

It is noted that in lieu of oil or in combination with oil, conventional fat substitutes may be used. Preferred fat substitutes employable in this invention include fatty acid-esterified alkoxylated glycerin compositions as well as sucrose fatty acid esters. The former and latter are described in U.S. Pat. Nos. 5,516,544 and 6,447,824, respectively, the disclosures of which are incorporated herein by reference. When employed, such conventional fat substitutes preferably make up at least about 30.0%, and most preferably, at least about 75.0% of the total weight of the oil in the emulsion produced.

The water used in this invention can be pure water, tap water, bottled water, deionized water, spring water, or a mixture thereof. Thus, the water used in this invention may be an aqueous solution comprising salts or minerals or both. The water in the compositions described herein can be an additive and/or supplied with ingredients, like fruit. Typically, water makes up the balance of the ready-to-serve and ambient stable fruit-based composition of this invention.

The emulsifier that may be used to make the ready-to-serve and ambient stable fruit-based composition of this invention often has an HLB of greater than about 9.0, and preferably, greater than about 11.0, and most preferably, from about 12.0 to about 18.0, including all ranges subsumed therein. Examples of the emulsifier suitable for use in this invention include PEG 20 tristearate, PEG 20 trioleate, PEG 20 monostearate, PEG 20 monooleate, PEG 20 monopalmitate and PEG 20 monolaurate sorbitan, derivatives thereof, mixtures thereof and the like, all made commercially available by ICI Surfactants under the names Tween or Span.

Other emulsifiers that may be used in this invention include nonionic copolymers of ethylene oxide and propylene oxide made available under the name Pluronic by BASF AG. Even other emulsifiers that may be used in this invention include lecithin, mono- and diglycerides, polysorbate 60, or a phospholipid, and especially, egg yolk derived phospholipids modified with a phospholipase (e.g., lecitase from Novo Nordisk) as disclosed in U.S. Pat. Nos. 5,028,447, 6,277,430, the disclosures of which are incorporated herein by reference. Suppliers of such phospholipids are, for example, M.G. Waldbaum Company and Inova Food Ingredients.

The amount of emulsifier employed in the ready-to-serve and ambient stable fruit-based composition of this invention is enough to typically yield a composition comprising from about 0.01 to about 2.0%, and preferably, from about 0.05% to about 1.0%, and most preferably, from about 0.2% to about 0.75% by weight emulsifier, based on total weight of the ready-to-serve and ambient stable fruit-based composition, and including all ranges subsumed therein. The preferred emulsifiers for use in this invention are polysorbate 60, a monostearate, lecithin or a mixture thereof.

Illustrative examples of the types of builders suitable for use in this invention include cellulose, locust bean, xanthan, carrageenan, guar gum, pectin, syrup, mixtures thereof and the like. Xanthan is the preferred builder and typically builders make up from about 0.02% to about 1.0% by weight of the total weight of the ready-to-serve and ambient stable fruit-based composition, including all ranges subsumed therein.

Preferred optional additives that may be combined with the acidified fruit-based composition to make the desired ready-to-serve and ambient stable fruit-based composition of this invention include mustard flour, chocolate, nut paste, salt, sugar, cilantro (and other spices and seasonings), vitamins, natural and artificial flavors (like those made available by Givaudan and/or International Flavors and Fragrances) and natural and artificial colors (e.g., beta carotene), fruit juice, preservatives, antioxidants, chelators, meat like ham and bacon bits or particulates, buffering agents, vegetable chunks, puree, bits or particulates, fruit (chunks, puree, bits or particulates), cheese, mixtures thereof and the like. Such optional additives, when used, collectively, usually do not make up more than about 65.0% by weight of the total weight of the ready-to-serve and ambient stable fruit-based composition.

The preferred preservatives suitable for use in this invention include sodium benzoate, potassium benzoate, potassium sorbate, sorbic acid, benzoic acid, mixtures thereof and the like. Anti-oxidants suitable for use in this invention include a tocopherol, ascorbic acid, ascorbyl palmitate, tertiary-butyl hydroquinone, mixtures thereof and the like. Chelators suitable for use in this invention include EDTA and its salts, citric acid, sodium tripolyphosphate, sodium carbonate, potassium carbonate, mixtures thereof and the like.

The fruit and vegetable chunks, puree, particulates or bits that may be used in this invention are typically smaller than 1.0 cm². The vegetables often include peppers, carrots, cabbage, onion, garlic, broccoli, mixtures thereof and the like. The fruits often include avocado, pears, apples, grapes, tomatoes, mixtures thereof and the like.

In a preferred embodiment, the ready-to-serve and ambient stable fruit-based composition of this invention comprises from about 10.0% to about 40.0% by weight pureed and/or chopped tomatillo, and about 1.0% to about 20.0% by weight pureed and/or chopped jalapeno pepper. In an especially preferred embodiment, optional additives, like onions, that will absorb water soluble colors, are pureed.

Still other additives which may be optionally added to make the ambient stable and ready-to-eat fruit-based composition of this invention include protein sources and sweeteners. The former include caseinate, whey, fractionated milk proteins, and skimmed milk powder and the latter include syrups, sucrose, glucose, saccharin, aspartame, dextrose, lactose, levelose, maltose, fructose, mixtures thereof and the like.

The ready-to-serve and ambient stable fruit-based composition of this invention is typically prepared by making the acidified fruit-based composition where oil may be added to fruit flesh prior to adding insoluble fiber. In a preferred embodiment, oil is added to the insoluble fibers prior to adding fruit flesh. Also, oil may be added to the insoluble fibers before or after water has been combined with the fibers. Emulsifier is also added to the insoluble fibers either before, with or after the addition of oil, but preferably before the addition of oil. Fat soluble additives (like flavors) can be added to the oil phase and water soluble additives like sugar, salt and preservatives can be added to the aqueous phase (along with builders) before the two phases are mixed to form a pre-emulsion or coarse emulsion. In an especially preferred embodiment, the oil with fat soluble additives is mixed with insoluble fibers, water and water soluble additives to produce a coarse emulsion. The coarse emulsion can then be subjected to a colloid mill or homogenizer to produce an emulsion of smaller oil droplet sizes.

When homogenized, the homogenization step is typically carried out under pressures from about 20.0 to about 650.0 bar, and preferably, from about 40.0 to about 600.0 bar, and most preferably, from about 45.0 to about 550.0 bar, including all ranges subsumed therein. Typically, such a homogenization step is carried out at a temperature from about 15.0° C. to about 70° C. (preferably about 25 to 46° C.) and for enough time to produce oil droplets whereby at least about 80.0% of the total amount of oil droplets formed in the resulting oil-in-water emulsion have a diameter which is less than about 10.0 microns. In a preferred embodiment, at least about 85.00% of the total amount of oil droplets present have a diameter which is less than about 8.0 microns. In an especially preferred embodiment, at least about 95.00% by weight of all oil droplets present have a diameter which is less than about 5.0 microns.

When the desired optional additives (e.g., jalapeno peppers, tomatillo) are subsequently combined with the emulsion having smaller oil droplet sizes, the resulting composition is a ready-to-eat fruit-based composition whereby the same is most preferably, a ready-to-eat guacamole composition. In an especially preferred embodiment, the ready-to-eat fruit-based composition is heated, for example, in heat exchangers like the Votators made available from Cherry Burrell. The ready-to-eat fruit-based composition (when having a pH greater than about 3.3, and optionally, when having a pH less than about 3.3) is heated for about 30.0 seconds to about 8.0 minutes, but preferably for about 2.0 minutes to about 4.0 minutes, including all ranges subsumed therein to render the same ambient stable. In a preferred embodiment, the temperature in the heat exchanger is from about 65° C. to a temperature that does not exceed about 80° C. In a most preferred embodiment, the heat exchanger is a scrape surface type, and the heating occurs for about 2.0 to about 4.0 minutes at a temperature from about 73.0° C. to a temperature that does not exceed about 80.0° C. In another most preferred embodiment, the pH of the ready-to-eat and ambient stable fruit-based composition is from about 2.75 to about 3.75.

It is also within the scope of this invention to heat the fruit not being supplied as optional additive in lieu of the ready-to-eat fruit composition when the resulting ready-to-eat and ambient stable fruit composition has pH above about 3.3. Such heating of the fruit is optional when the pH of the resulting ready-to-eat and ambient stable fruit-based composition is less than about 3.3, where, again, starch is preferably added after heat treating when the starch is an acetylated distarch adipate.

The packaging for the ready-to-eat and ambient stable fruit-based composition of this invention is often a glass jar, food grade sachet or squeezable plastic bottle. Sachets are preferred for food service solutions, and a glass jar is preferred for domestic use. In a preferred embodiment the packaging is filled cold, and most preferably, ultra clean or aseptically.

The viscosity of the ready-to-serve and ambient stable fruit-based composition of this invention is typically greater than about 3,000 and less than about 150,000 centipoise. When a sauce or pourable dressing is, for example, the desired composition, the viscosity of the composition is preferably from about 4,000 to about 10,000 centipoise, and most preferably, from about 4,350 to about 6,000 centipoise.

When the desired ready-to-serve and ambient stable fruit-based composition is, for example, a filling, dip, spread or spoonable dressing, the viscosity of the food product is preferably from about 12,000 to about 120,000 centipoise, and most preferably, from about 16,000 to about 80,000 centipoise, whereby the viscosity of the composition is measured on a Haake Rheometer (Rotovisco RV20) at room temperature using a set of concentric cylinders (or bob-in-cup) with a 1 mm gap, the bob having a diameter of 1.0 cm and length of 1.0 cm. The inner cylinder or bob starts rotating from 0 shear and ramps up to a shear rate of 134 sec⁻¹ in 542 sec. By way of comparison, the viscosity values refer to the shear rate of 10 sec⁻¹.

The Examples are provided to facilitate an understanding of the present invention and are not meant to limit the scope of the claims.

### EXAMPLE 1

Acidified avocado-based compositions having a fork-mashed texture were made by mixing the following ingredients:

TABLE 1

| | Percent by Weight based on |
|---|---|
| | total weight of the |
| | Ready-to-eat guacamole composition |
| A. Ingredient-Oil Phase | |
| Soybean oil | 19.0 |
| Polysorbate 60 | 0.26 |
| B. Ingredient-Fiber Phase | |
| Water | Balance |
| Pectin | 0.08 |
| Sorbic Acid | 0.10 |
| Citrus fiber | 2.60 |
| Potato starch | 1.00 |
| Milk powder | 0.75 |
| Hydrochloric acid | 0.09 |
| Xanthan gum | 0.13 |
| Corn syrup | 11.13 |
| EDTA | 0.007 |
| Color | 0.075 |
| Sugar | 1.00 |
| Salt | 1.02 |
| C. Ingredient-Final Mix | |
| Fiber phase | 60.0 |
| Oil phase | 18.9 |
| Avocado flesh | 20.0 |
| Hydrochloric acid | 0.24 |
| Water | Balance |

Ingredients of the oil and fiber phases were combined and mixed under moderate shear at atmospheric pressure and ambient temperature in a conventional mixer to produce a coarse emulsion. The coarse emulsion was then subjected to a homogenizer (e.g., APV Gaulin Homogenizer).pressurized to about 250 bar. The resulting emulsion was combined with the ingredients in the final mix to produce an acidified avocado-based composition having a fork-mashed texture. The same was then subjected to a votator for about three (3) minutes at 75° C. to produce an ambient stable, acidified avocado-based composition.

### EXAMPLE 2

Ambient stable, acidified avocado-based compositions having a fork-mashed texture were made in a manner similar to the one described in Example 1 except that oxidised starch (at 3.5%) was used in lieu of potato starch. The oxidized starch was added as part of the final mix and not the fiber phase, and the citrus fiber level was reduced to 1.0%.

### EXAMPLE 3

Ambient stable, acidified avocado-based compositions having a fork-mashed texture were made in a manner similar to the one described in Example 2 except that the starch used was an acetylated distarch adipate in lieu of oxidized starch. The starch was added and mixed in to the composition after votating.

### EXAMPLE 4

The ambient stable, acidified avocado-based compositions of Examples 1-3 were compared to conventional avocado-based compositions not subjected to the heat and acid treatments as defined in this invention and not comprising the fiber and starch combination as described herein. Surprisingly, after about eight (8) weeks, the former looked fresh, was not rancid or brown and tasted substantially the same as freshly made fork-mashed avocado-base. The latter was not edible.

Moreover, the latter, even when made with fork-mashed fruit, did not maintain its fork-mashed texture as did the acidified avocado-based composition of this invention.

What is claimed is:

1. An acidified fruit-based composition comprising:
(a) fruit;
(b) water;
(c) acidulant; and
(d) a thickener mixture comprising starch and insoluble fiber
wherein the acidified fruit-composition has a pH below about 4.0 and the thickener mixture comprises at least about 3.5% by weight starch and at least about 20.0% by weight insoluble fiber based on total weight of the thickener mixture.

2. The acidified fruit-based composition according to claim 1 wherein the acidified fruit-based composition is substantially free of fork-mashed fruit but has a fork-mashed texture.

3. The acidified fruit-based composition according to claim 1 wherein the acidified fruit-based composition is free of fork-mashed fruit but has a fork-mashed texture.

4. The acidified fruit-based composition according to claim 1 wherein the amount of insoluble fiber is at least about 1.5 times the amount of starch.

5. The acidified fruit-based composition according to claim 1 wherein the starch is potato starch, a starch having an E number of 1404, a starch having an E number of 1422 or a mixture thereof.

6. The acidified fruit-based composition according to claim 1 wherein the acidified fruit-based composition further comprises oil and an emulsifier.

7. The acidified fruit-based composition according to claim 6 wherein the emulsion has at least about 80.0% of its oil droplets with a diameter of less than about 10.0 microns.

8. The acidified fruit-based composition according to claim 1 wherein the acidified fruit-based composition is ambient stable.

9. The acidified fruit-based composition according to claim 8 wherein the fruit is avocado.

10. The acidified fruit-based composition according to claim 1 wherein the acidulant is hydrochloric acid.

11. A ready-to-serve and ambient stable fruit-based composition comprising the acidified fruit-based composition of claim 1.

12. The ready-to-serve and ambient stable fruit-based composition according to claim 11 wherein the composition has at least about 1.5 times more insoluble fiber than starch.

13. The ready-to-serve and ambient stable fruit-based composition according to claim 11 wherein the amount of insoluble fiber is at least about 1.0 by weight and the amount of starch is less than about 4.0% by weight of the ready-to-serve and ambient stable fruit-based composition.

14. The ready-to-serve and ambient stable fruit-based composition according to claim 11 wherein the composition has less than about 20.0 ppm of extracellular terminal unsaturated ester.

15. The ready-to-serve and ambient stable fruit-based composition according to claim 11 wherein the composition has a fork-mashed texture and is substantially free of fork-mashed fruit.

16. The ready-to-serve and ambient stable fruit-based composition according to claim 11 wherein the composition has a fork-mashed texture and is free of fork-mashed fruit.

17. The ready-to-serve and ambient stable fruit-based composition according to claim 11 wherein the composition is a guacamole.

18. A method for making a ready-to-serve and ambient stable fruit-based composition having a fork-mashed texture comprising the steps of:
(a) combining fruit puree, oil, emulsifier, water, acidulant, and fiber to produce a mixture; and
(b) heating the mixture to produce a food composition
wherein starch which is potato starch and/or a starch with an E number of 1404 is/are added to the mixture prior to heating, and/or starch having an E number of 1422 is added to the food composition after heating.
